(19) United States
(12) Patent Application Publication
(10) Pub. No.: US 2006/0079232 A1
(43) Pub. Date: Apr. 13, 2006

(54) Wireless LAN handover method, wireless terminal, program product for use in the wireless terminal, and wireless communications system

(75) Inventors: Youko Omori, Tokyo (JP); Shinichi Morimoto, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation

(21) Appl. No.: 11/230,891

(22) Filed: Sep. 21, 2005

(30) Foreign Application Priority Data
Sep. 22, 2004 (JP) 274867/2004

(51) Int. Cl. H04Q 7/20

(52) U.S. Cl. 455/436; 455/574

(57) ABSTRACT

A wireless terminal is associated with a Basic Service Set (BSS) or an Independent Basic Service Set (IBSS). The wireless terminal notifies the currently associated target of transition into power saving mode, before migrating from the currently associated BSS or IBSS to another BSS or IBSS. Subsequently, the wireless LAN terminal starts searching for another BSS or IBSS which is the next candidate target to be associated with.

### BACKGROUND OF THE INVENTION

1. Field of the Invention

The present invention relates to a wireless communication system, and particularly to a wireless handover technique for wireless terminal having a power saving function.

2. Description of the Related Art

When communication quality between a wireless terminal and a wireless base station degrades, the wireless terminal searches for another base station. Then, based on the search result, the wireless terminal is associated with another wireless base station having the best communication quality and continues the communication. Such a technique is referred to as handover. The handover technique is employed in cellular telephone systems, wireless LAN systems, or the like.

As an approach to reduce communication loss when performing handover, a technique has been devised for reducing the time required for handover. The technique is described in JP-A 2004-207922 bulletin (Document 1) and JP-A 8-191305 (1996) bulletin (Document 2), for example.

According to the method described in Document 1, the wireless terminal preliminarily searches for a base station or an access point (AP), and saves the search result as an access point connection candidate list (“AP connection candidate list”, hereafter). Then, when the communication quality degrades, the wireless LAN terminal determines a base station to which it may be handed over from the AP connection candidate list, without searching for a base station.

According to the method described in Document 2, the wireless terminal periodically searches for a connectable base station, and stores the result in a management table. Then, the wireless LAN terminal is connected to a base station stored in the management table when the communication condition degrades.

According to these methods, communication loss after the degradation of communication quality can be reduced, because the search time is reduced. However, these methods can not prevent communication loss which occurs during the search for a base station, an access point, or a wireless network. Communication loss which occurs during the search will be described below.

FIG. 1 illustrates a wireless LAN system operating in infrastructure mode, which is standardized by the Institute of Electrical and Electronics Engineers (IEEE) 802.11. The system of FIG. 1 comprises one or more access points (AP), or base stations 101 to 103, and one or more terminals 104 and 105. The access points and the terminals constitute the Basic Service Sets (BSS) 106,107, and 108, with the APs being the core and the terminals associated with such APs. In addition, the wireless LAN system includes a network 109 connecting between the BSSs. The network may be connected to other wired LANs.

FIG. 2 illustrates a wireless LAN system operating in ad-hoc mode. The ad-hoc mode is standardized by IEEE 802.11. The system of FIG. 2 includes one or more terminals 201 to 205. As shown in FIG. 2, the terminals 201 to 203 are associated with an Independent Basic Service Set (IBSS) 206, whereas the terminals 204 and 205 are associated with IBSSs 207 and 207.

In both infrastructure mode and the ad-hoc mode, a wireless AN terminal is configured, in principle, to be associated with only one BSS or IBSS for performing communication.

The only exception occurs when the wireless LAN terminal is performing handover. The terminal may be temporarily associated with both the BSS which is currently in communication and the BSS to which it may be handed over. Here, handover refers to an operation of migrating from the BSS or IBSS with which the terminal is currently associated to another BSS or IBSS. A terminal associated with a BSS or IBSS can communicate with other BSSs or IBSSs to search for handover targets.

The terminal searches for a candidate to be newly associated with, using either passive scan or active scan.

In a passive scan search, the terminal receives signals transmitted from or received by other BSSs or IBs (particularly, beacon signals used for clock synchronization of the network) and detects a candidate to be newly associated with. In an active scan search, the terminal transmits a probe request as a broadcast packet, and detects a BSS or IBSS as a candidate to be newly associated with, by receiving a probe response which is the response to the probe request.

In this case, the wireless channel of another BSS (or IBSS) may not be identical to the wireless channel being used by the BSS or IBSS with which the terminal is currently associated. The terminal may perform, during the search, transmission or reception via a channel which is different from the channel currently in communication.

FIG. 3 illustrates how a terminal 104 (FIG. 1) operating in infrastructure mode performs a search for a target to be newly associated with, under a condition such that the terminal is already associated with AP 101. FIG. 3 depicts the signal flow with the horizontal axis representing time, upward arrows representing signals transmitted by the terminal (uplink data packet) and downward arrows representing signals transmitted by the AP (downlink packet).

AP 101 and AP 102 periodically transmit beacons (B) 300 and 301 via different channels, respectively.

As shown in FIG. 1, the terminal 104 is associated with BSS 106 constituted with AP 101 as the core, and performs communication. AP 101 transmits a downlink data packet 302 to the terminal 104. The terminal 104 returns an acknowledgement (ACK) 303 indicating reception of the downlink data packet 302 to AP 101. The terminal 104 also transmits an uplink data packet 304 to AP 101. AP 101 then returns ACK 305 indicating reception of the uplink data packet 304 to the terminal 104

The terminal 104 communicating with AP 101 migrates from the channel currently in communication to the channel of another AP 102 from time point t1 in order to search for a new target to be associated with. Then, the terminal 104 transmits a probe request 306 to perform the search at time point t2. Upon reception of the probe request 306 from the terminal 104, AP 102 transmits a probe response 307 as a response thereto.

In the terminal 104, two types of timer value defined in IEEE 802.11 are set for the search. If the terminal 104 failed to detect an AP within a minimum channel time T1 since the search of the AP started, the search of the AP is terminated. On the contrary, the terminal 104 succeeded in detecting the AP within T1, the search time is extended to a maximum channel time T2.

In FIG. 3, the terminal receives the probe response 307 from AP 102 in T1, then the terminal 104 transmits ACK 308 indicating that the probe response 307 has been received. In other words, the terminal 104 has detected a new AP 102 within the minimum channel time T1. Therefore, the terminal 104 extends the search time to the end of the maximum channel time T2, and returns to the channel of AP 101 which is the currently associated target, at time point t4.

During the period from time point t1 to t4, the terminal 104 did not exist in the channel of AP 101. Therefore, AP 101 cannot receive ACK corresponding to the downlink data packet transmitted fromAP 101 during the period. Thus, AP 101 repeats re-transmission 309 of the downlink data packet to the terminal 104.

As thus described, the terminal searching for a new BSS or IBSS cannot receive the downlink data packet transmitted from the AP during this period because the terminal has migrated from the channel in communication to another channel being searched for. The AP with which the terminal is associated transmits the downlink data packet, even if the terminal is searching for a new target to be associated with. If a reception acknowledgement (ACK) from the terminal was not obtained after a maximum number of re-transmission times, the AP discards the downlink data packet. Thus, the terminal cannot receive the downlink data packet discarded by the currently associated AP, even after the terminal finished the search and returned to the channel of the currently associated AP.

Additionally, frequent search for an AP by the terminal increases the load on the wireless network. If ACK corresponding to the downlink data packet cannot be received, the AP repeats re-transmission of the downlink data packet. The re-transmission is repeated for an upper limit of re-transmission times which is preliminarily set in the AP. The re-transmission increases the load on the wireless network.

Furthermore, the terminal may be dissolved of association by the AP with which it is currently associated, during the search for another channel. The AP maintains an association table for managing currently associated the terminals. In view of the number of re-transmission times to, a particular the terminal, the AP determines whether or not the terminal is non-existent. The AP may delete the terminal determined as non-existent from the association table. If the terminal is deleted from the association table, it can no longer communicate with the AP after the terminal returned from the search for another channel. The terminal deleted from the association table needs to perform a process of re-association to the AP.

### SUMMARY OF THE INVENTION

A first exemplary feature of the present invention is to provide a technique for improving network transmission efficiency and reliability of the network, by preventing re-transmission and loss of inbound packets in the wireless segment when the currently associated the terminal is searching for another BSS or IBSS.

In the first exemplary handover method of the present invention, a wireless terminal associated with a BSS (or IBSS) searches for another BSS or IBSS, after having preliminarily notified its transition into power saving mode to the currently associated BSS or IBSS, or after having preliminarily and intentionally transited into power saving mode.

In order to prevent loss of downlink data packets to the terminal in power saving mode, the base station (or access point: AP) stores the electric power management status of the currently associated the terminal. If the terminal is in active mode, the base station transmits the packets. If the terminal is in power saving mode, the base station buffers (temporarily accumulates inside) downlink data.

When buffering packets addressed to the terminal, the AP indicates the identifier of the terminal in the Traffic Indication Map (TIM) information of the beacon. If the identifier of its own station is included in the TIM information, the terminal requests (for examples by a Power Saving Poll (PS-Poll) frame) transmission of the packets buffered in the AP. In response to the transmission request, the base station transmits these packets.

In other words, the terminal searches for another BSS or IBSS under a condition wherein the AP or the base station recognizes that the terminal is in power saving mode.

The first exemplary handover method of the present invention provides the following advantages. First, since the terminal notifies the AP of its transition from active mode into power saving mode before scanning the newly-associated target, the packets addressed to the terminal are buffered by the AP even after if the terminal has migrated to another channel. Therefore, loss of downlink packets can be prevented by the terminal returning to the original channel and requesting packets within a predefined time period. In addition, upon reception of a notification of transition into power saving mode from the terminal, AP restrains transmitting packets to the terminal. Therefore, increase of network load due t6 wasteful re-transmissions does not occur.

Furthermore, in the first exemplary method of the present invention, the terminal notifies AP of its transition from active mode into power saving mode, before searching for a target to be newly associated with. Therefore, the terminal can avoid being dissolved of its association, because the base station determines that the terminal has transited into a Doze status even if the terminal temporarily migrated to another channel.

The other features and aspects of the present invention will be clear through the description in of preferred embodiments.

### BRIEF DESCRIPTION OF THE DRAWINGS

In the accompanying drawings,

FIG. 1 illustrates an example of a wireless LAN system operating in infrastructure mode;

FIG. 2 illustrates an example of a wireless LAN system operating in ad-hoc mode;

FIG. 3 illustrates the conventional search timing during communication in FIG. 1;

FIG. 4 illustrates the constitution of the wireless terminal in FIG. 1;

FIG. 5 illustrates the constitution of the wireless layer controller in FIG. 4;

FIG. 6 illustrates the search timing during communication applying the present invention, in the system of FIG. 1;

FIG. 7 illustrates a data frame format;

FIG. 8 is a flow chart describing the search for a BSS or IBSS according to the present invention;

FIG. 9 is flow chart showing details of FIG. 8;

FIG. 10 is flow chart showing details of FIG. 8;

FIG. 11 is flow chart showing details of FIG. 8;

FIG. 12 illustrates search timing during communication in embodiment 1;

FIG. 13 illustrates search timing during communication in embodiment 2;

FIG. 14 illustrates search timing during communication in embodiment 3;

FIG. 15 illustrates an exemplary constitution of the wireless LAN system in embodiment 4:

FIG. 16 illustrates search timing during communication in embodiment 4;

FIG. 17 illustrates the Association Management frame format;

FIG. 18 illustrates search timing during communication in embodiment 5; and

FIG. 19 illustrates search timing during communication in embodiment 6;

### DETAILED DESCRIPTION OF THE PREFERRED EMBODIMENTS

Embodiments of the present invention will be described in detail referring to the drawings.

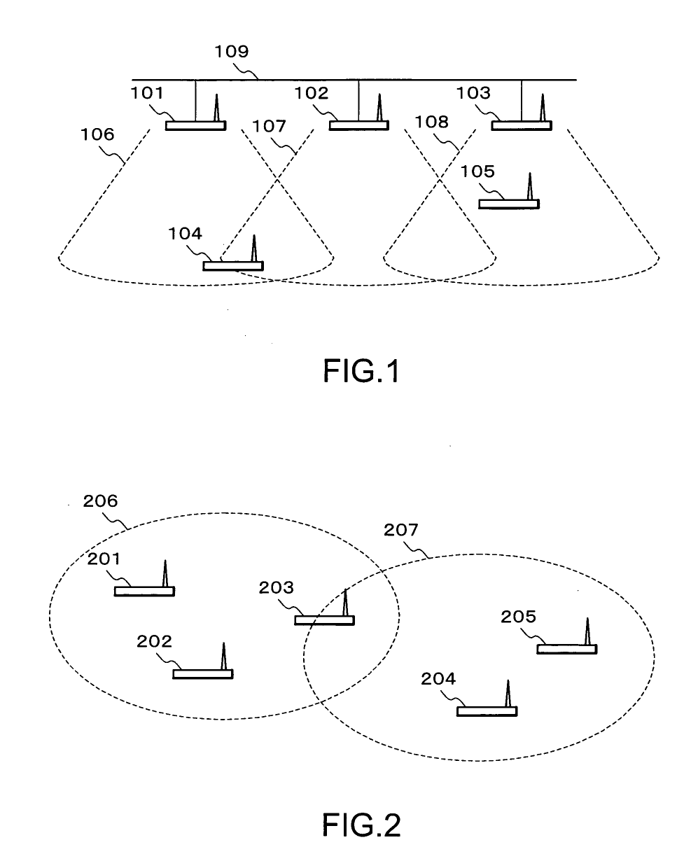

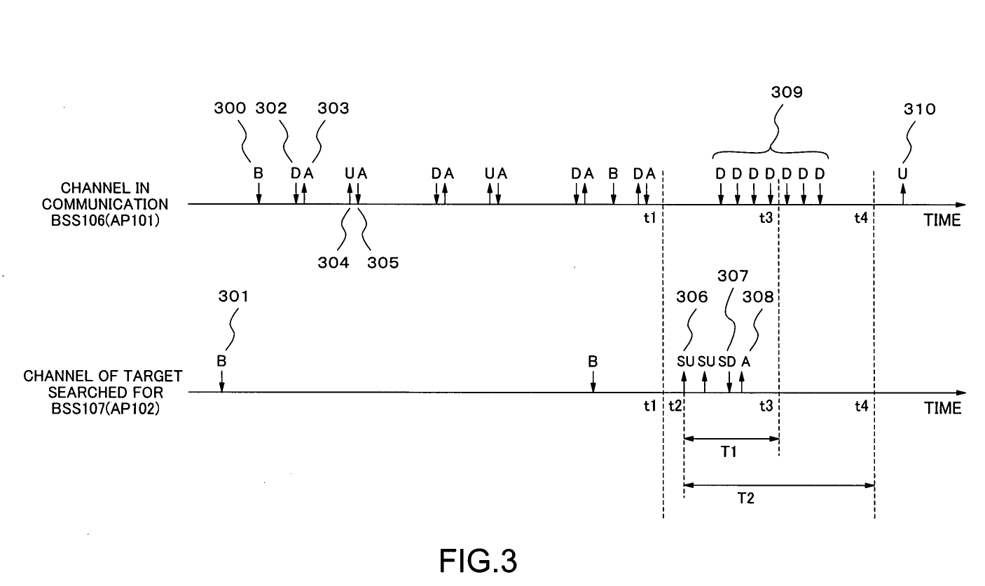

One of the system related to the present invention comprises BSSs 106, 107 and 108, and another network 109 connecting between the BSSs as shown in FIG. 1. Each BSS is composed of a single AP (Access Point or base station) and one or more terminals.

The APs 101 to 103 and the terminals 106 to 108 preferably have a power saving function (power saving mode) defined in IEEE 802.11

In the power saving mode defined in IEEE 802.11, the terminal intermittently (cycle: Listen Interval) receives the beacon which is periodically (cycle: Beacon Interval) transmitted from the base station, and suppresses power consumption by staying in a sleep. (Doze) state for the rest of the period.

For the terminal in the power saving mode, the base station stores the electric power management status of the currently associated terminals to prevent downlink data packet loss. The base station transfers the downlink data if the terminal is in the active mode, whereas the base station buffers the downlink data if the terminal is in the power saving mode. Then, the base station needs to buffer the packets for the terminal in the power saving mode during the Listen Interval. Therefore, the base station determines a Listen Interval acceptable in view of memory capacity of its own, and notifies the terminal of the Listen Interval when the terminal performs a re-association process.

When the AP is buffering the packets addressed to the terminal, the identifier of the terminal is described in TIM information of the beacon. The terminal requests transmission (by the PS-Poll frame) of the buffered packets, if the identifier of its own is indicated on TIM. In response to the request, the base station transmits the packet which had been buffered.

The terminal notifies the base station that it is in power saving mode by setting the Power Management bit of the transmission packet to “1”. The Power Management bit is set to “1” in all of the packets transmitted from the terminal to the currently associated base station, not only when the terminal is transiting to power saving mode but also during power saving mode. The Power Management bit of the transmission packet is set to “0” When transiting to active mode and operating in active mode. Even if the terminal is in power saving mode, the timing of the packets transmitted from the terminal to the base station can be transmitted at an arbitrary timing as with the case when the terminal is operating in active mode.

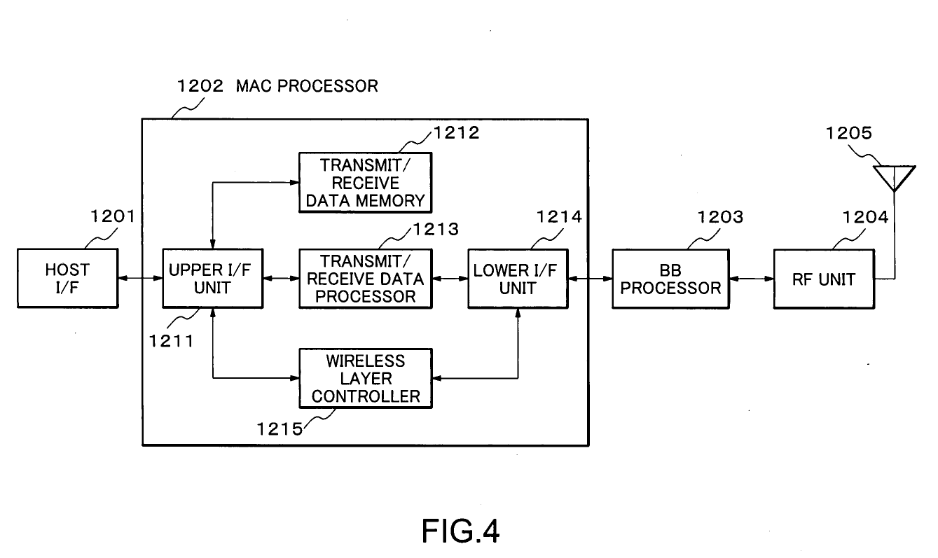

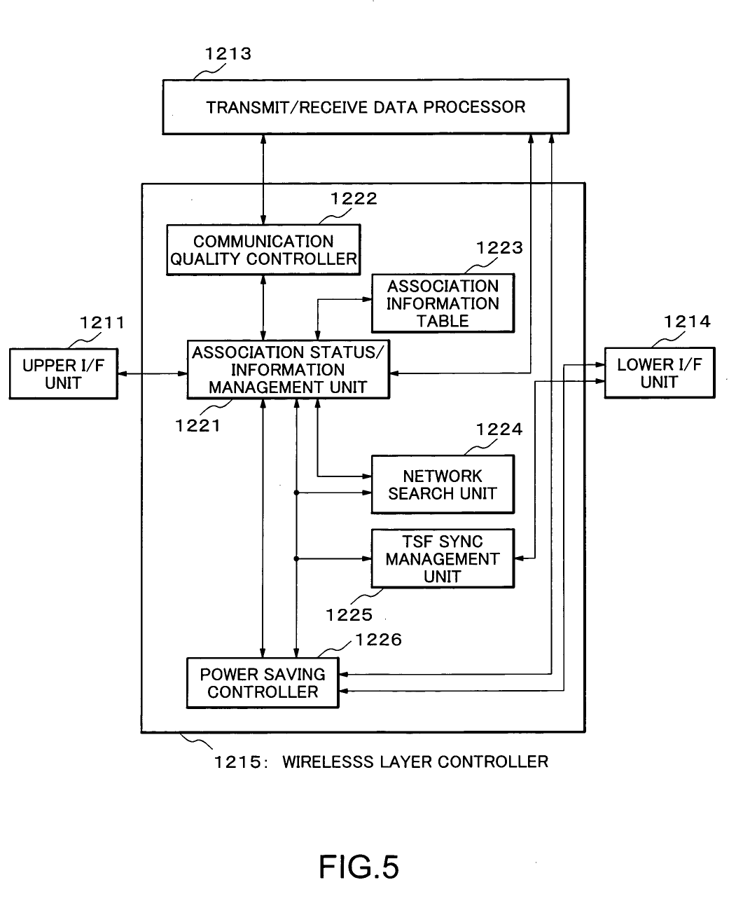

The constitution of the terminal 104 will described using FIG. 4 in the following.

As shown in FIG. 4, the terminal 104 comprises a host I/F 1201 which is the interface (I/F) between the host using wireless LAN devices, a Media Access Control (MAC) processor 1202 for processing the MAC layer of the wireless LAN, a base band (BB) processor 1203 for processing base band (BB) signals of the wireless LAN, an RF unit 1204 for processing the Radio Frequency (RF) band signals of the wireless LAN and an antenna 1205.

Here, the MAC processor 1202 comprises an upper I/F unit 1211 for serving as the interface between the host I/F 1201, a transmit/receive data memory 1212 for storing transmitted or received data, transmit/receive data processor 1213 for processing transmitted or received data, a lower I/F unit 1214 for serving as the interface between the BB processor 1203, and a wireless layer controller 1215 for controlling the wireless layer.

An exemplary constitution of the wireless layer controller 1215 is shown in FIG. 5.

As shown in FIG. 5, the wireless layer controller 1215 comprises an association status/information management unit 1221 for managing information required for associating the terminal 104 and the status of the associations; an association information table 1223 for storing information of the BSS or IBSS with which the terminal 104 is associated; a communication quality controller 1222 for managing and controlling the communication quality of the transmitted or received data of the terminal 104; a network search unit 1224 for searching for a BSS or IBSS; a TSF synchronization management unit 1225 for managing synchronization information of the terminal 104; and power saving controller 1226 for managing and controlling the power saving operation of the terminal 104.

In such a constitution, an operation of the terminal 104 (FIG. 1) associated with AP 101 searching for another AP will be described.

The terminal 104, being associated with AP 101, communicates in infrastructure mode. The data transmitted by the terminal is input to the upper I/F unit 1211 via the host I/F unit 1021. The upper I/F unit 1211 stores the data to be transmitted in the transmit/receive data memory 1212, and notifies the transmit/receive data processor 1213 that the transmitted data has been input.

The transmit/receive data processor 1213 uses the notification from the upper I/F unit 1211 and the information from the wireless layer controller 1215, and converts the transmitted data in the transmit/receive data memory into the wireless LAN data format. Then, the transmit/receive data processor 1213 notifies the lower I/F unit 1214 of a transmission request and waits for an opportunity of transmission.

The lower I/F unit 1214 determines the transmission timing based on the information from the BB processor 1203 and the wireless layer controller 1215, and notifies it to the transmit/receive data processor 1213. Following the instruction of the lower I/F unit 1214, the transmit/receive data processor 1213 immediately supplies the transmitted data which is converted into the wireless LAN format to the lower I/F unit. The lower I/F unit 1214 supplies the transmitted data to the BB processor 1203 together with information required for transmitting such as transmission rate, which is instructed by the wireless layer controller 1215. The transmitted data goes through baseband processing in the BB processor 1203, and transmitted via the RF unit 1204 and the antenna 1205.

The received data, on the other hand, is input to the lower I/F unit 1214 via the antenna 1205, the RF region 1204, and the BB processor 1203. The lower I/F unit 1214 inputs the received wireless frame into the transmit/receive data processor 1213. If the received wireless frame is a data frame, the transmit/receive data processor 1213 stores the received data frame in the transmit/receive data memory 1212, and notifies the presence of the received data to the upper I/F unit 1211. On the other hand, if the received wireless frame is a Management frame or a Control frame, the transmit/receive data processor 1213 notifies the wireless layer controller 1215.

In the course of these transmission/reception processes, the transmit/receive data processor 1213 notifies communication quality related information to the wireless layer controller 1215, such as number of re-transmission times of the transmitted data, transmission rate for transmitting, received power, received error, transmission rate for receiving. The transmit/receive data processor 1213 also performs transmission of the Management frame, the Control frame, and the Null function data frame in response to requests from the wireless layer controller 1215, and notifies the result to the wireless layer controller 1215.

Control of the wireless layer of the terminal 104 is performed in the wireless layer controller 1215. As shown in FIG. 5, the upper I/F unit 1211 notifies information of the network to be associated with, i.e., information such as SSID or channels to be used, to the association status/information management unit 1221.

The association status/information management unit 1221, on the other hand, notifies the status of the current association to the upper I/F unit 1211.

The communication quality controller 1222 determines degradation of the communication quality based on the communication quality related information notified from the transmit/receive data processor 1213. The communication quality is then notified to the association status/information management unit 1221.

The association status/information management unit 1221 starts the search, based on the transmitted and received data, or the communication quality. Here, starting condition of the search will not be described. The association status/information management unit 1221 configures the network search unit 1224 with information required for the search, and at the same time requests the power saving controller 1226 of transition into power saving mode. The power saving controller 1226, in response to the request from the association status/information management unit 1221, starts notifying AP 101 of transition into power saving mode.

In order to notify AP 101 of transition into power saving mode, the power saving controller 1225 instructs the transmit/receive data processor to set the Power Management bit to “1” at the conversion of the uplink data packet, i.e. the transmitted data into the wireless frame format, whereby the uplink data packet transmitted from the terminal 104 notifies AP 101 of transition into power saving mode. Upon receiving notification of successful transmission of a packet with the above-mentioned Power Management bit set to “1” from the transmit/receive data processor 1213, the power saving controller 1226 immediately notifies the association status/information management unit 1221 that notification to AP 101 has been completed.

The association status/information management unit 1221 notifies the transmit/receive data processor 1213 of transition into search state at the timing when the notification to AP 101 of transition into power saving mode is completed, and instructs the start of search to the network search unit 1224.

The transmit/receive data processor 1213 does not perform normal data transmission during the network search.

The network search unit 1224 notifies the channel required for the search to the transmit/receive data processor 1213 via the association status/information management unit 1221, and inputs the probe request frame format required for the search. A probe request is transmitted from the transmit/receive data processor 1213, via the lower I/F unit 1214. A probe response corresponding to the probe request is inputted to the network search unit 1224 from the transmit/receive data processor 1213, via the association status/information management unit 1221.

The network search unit 1224 completes the search based on synchronization information from the TSF synchronization management unit 1225 and a predefined search time, and notifies the search result to the association status/information management unit 1221.

Upon receiving notification of completion of the search from the network search unit 1224, the association status/information management unit 1221 notifies the transmit/receive data processor 1213 of completion of the search. The association status/information management unit 1221 also requests transition from power saving mode into active mode, to the power saving controller 1226.

Upon receiving notification of completion of the search, the transmitted and received data processor 1213 restarts the normal data transmission.

In response to the request from association status/information management unit 1221, the power saving controller 1226 starts the process of notifying AP 101 of transition into active mode. In order to notify AP 101 of transition into active mode, the power saving controller 1226 instructs the transmit/receive data processor to set the Power Management bit to “0” at the conversion of the uplink data packet, i.e. the transmitted data into the wireless frame format, whereby the uplink data packet transmitted from the terminal 104 notifies AP 101 of transition into active mode. Upon receiving notification of successful transmission of a packet with the above-mentioned Power Management bit set to “0” from the transmit/receive data processor 1213, the power saving controller 1226 notifies the association status/information management unit 1221 that notification to AP 101 has been completed.

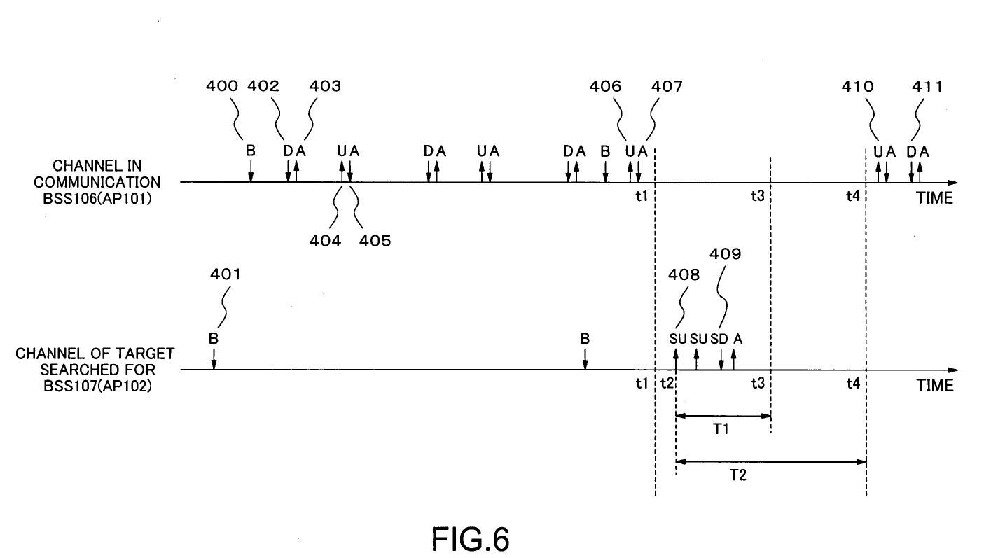

FIG. 6 illustrates how the terminal 104 of FIG. 1 searches for a new candidate to be associated with. The terminal 104, operating in infrastructure mode, is associated with AP 101. FIG. 6 depicts the signal flow with horizontal axis representing the time, upward arrows representing signals transmitted by the terminal (uplink data packet) and downward arrows representing signals transmitted by the AP (downlink packet).

AP 101 and AP 102 periodically transmit beacons (B) 400 and 401 via different channels, respectively.

The terminal 104 is associated with BSS 106 constituted with AP 101 as the core, and performs communication. Packets 402 to 405 represent, respectively, a downlink data packet (D) from AP 101 to the terminal 104, an ACK (A) for the downlink data packet 402, an uplink data packet (U) from the terminal 104 to AP 101, and ACK for the uplink data packet 404.

The terminal 104 communicating with AP 101 migrates from the channel currently in communication (channel for AP 101) to the channel of AP 102 from time point t1 in order to search for an AP. For preparation, the terminal 104 uses, at a time point before t1, an uplink data packet 406 to notify AP 101 of transition into power saving mode. The notification of transition into power saving mode is performed by setting the Power Management bit included in the packet to “1”.

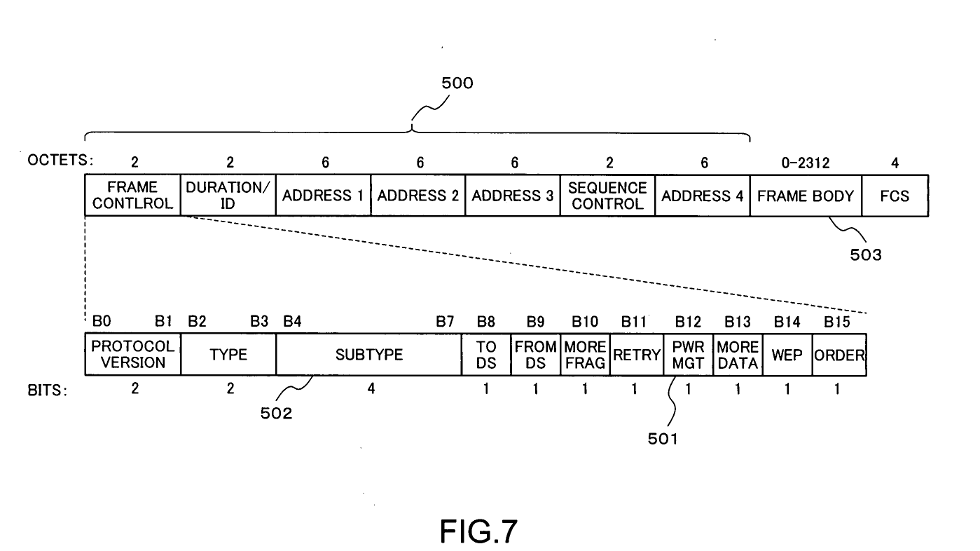

FIG. 7 illustrates a general data frame format of an uplink data packet. The Power Management bit (Pwr Mgt) 501 included in the MAC header 500 is set to “1” only when in power saving mode. When a frame with the Power Management bit set to “1” is received from the terminal, the AP buffers the downlink data thereafter. The data buffered in the AP is transmitted to the terminal after a downlink data request packet (PS-Poll frame) has been received from the terminal.

In FIG. 6, since an uplink data packet 406 with the Power Management bit set to “1” has been received, AP 101 restrains transmitting downlink data packets to be generated thereafter and temporarily stores them internally.

The terminal 104, on the other hand, recognizes by receiving ACK 407 that AP 101 received the notification of transition into power saving mode. Then, in order to search for a candidate to be newly associated with, the terminal 104 migrates to the channel of BSS 107 at time point t1 and transmits a probe request (SU) 408 at time point t2. AP 102 transmits a probe response (SD) 409, as reply to the probe request of the terminal 104.

Since the terminal 104 detected a new AP (AP 102) within a minimum channel time T1, the search time is extended to the end of the maximum channel time T2, returns to the channel of AP 101 which had been communicating before time point t1, at time point t4.

Then, the terminal 104 transmits an uplink data packet 410 with the Power Management bit set to “0”. By transmission of the uplink data packet 410, the terminal 104 notifies AP 101 of release from power saving mode, i.e., return to active mode.

The AP 101 detects that the terminal 104 can receive downlink data packets by reception of the uplink data packet 410. The AP 101 then sequentially transmits downlink data packets 411 which were created during the period between time points t1 and t4, and buffered in the AP. In addition, downlink data packets created thereafter are transmitted without being buffered.

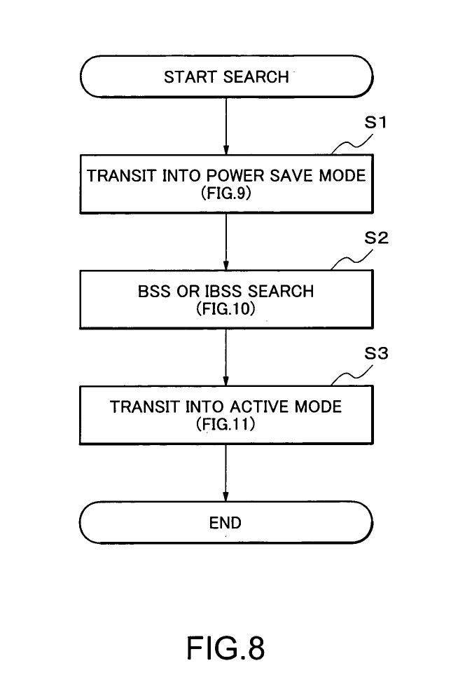

Flow of the search process in the terminal will be described, referring to FIGS. 8 to 11. Here, the search process is applicable to either a terminal operating infrastructure mode, or a terminal operating in ad-hoc mode.

FIG. 8 is a flow chart explaining the process from the start to the end of the search of the terminal 104 which is in communication. When the search starts, the terminal transits into power saving mode in step s1. Then, in step s2, the terminal searches for a BSS or IBSS. After the search has been completed, the terminal transits into active mode in step s3, and the search is finished.

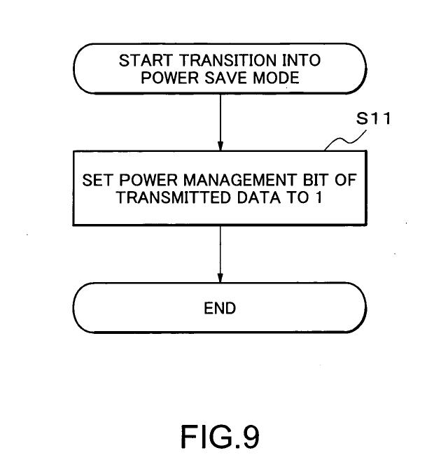

In step s1, the terminal sets the Power Management bit of the uplink data packet to “1” in order to start transition into power saving mode, as shown in FIG. 9, and transmits the uplink data packet (step s11).

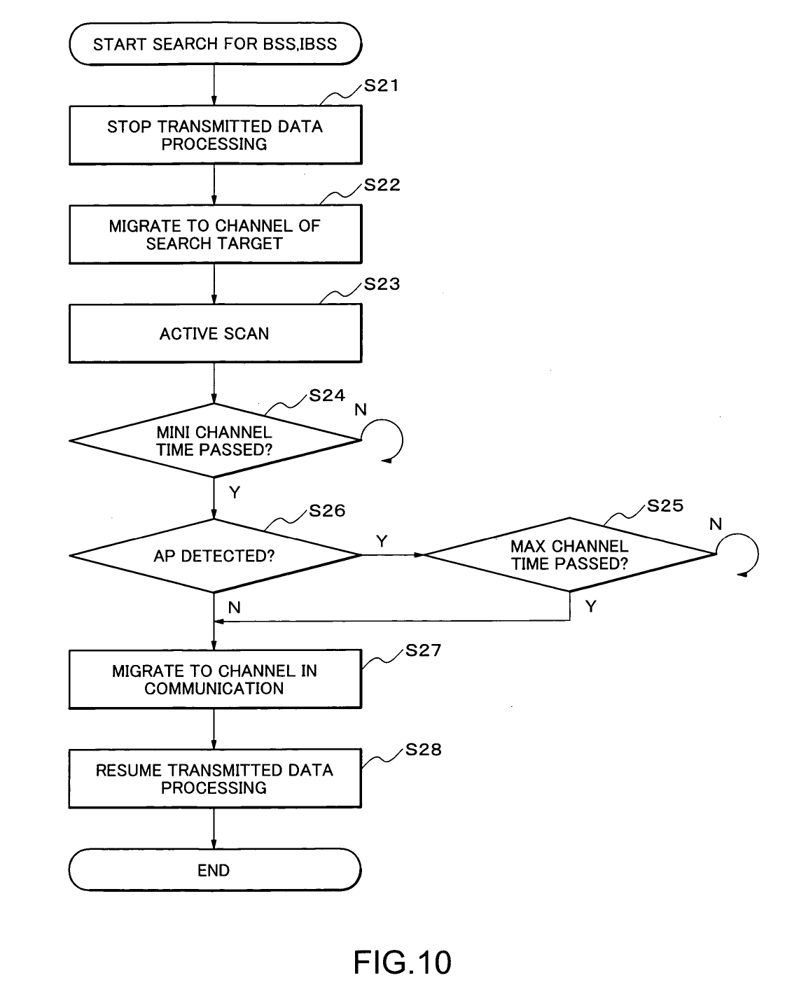

FIG. 10 is a flow chart illustrating details of the search process (step s2) of the BSS or IBSS. First, the terminal stops the data transmission process in step s21, and migrates to the channel of target being search for, in step s22.

In step s23, the terminal searches for the BSS (or IBSS) in the search target channel. In other words, the above-mentioned active scan is performed. That is, the terminal transmits the above-mentioned probe request via a search channel. The terminal then waits for passage of a minimum channel time, in step s24. After the minimum channel time has passed, the process of the terminal proceeds to step s26.

In step s26, the terminal determines whether or not it received a probe response. If the terminal was not able to receive the probe response, i.e., if it failed to detect the AP within the minimum channel time (T1), the process of the terminal proceeds to step s26. If the probe response has been received, the process of the terminal proceeds to step s25 and waits for passage of a maximum channel time (T2). After the maximum channel time course has passed, the process of the terminal proceeds to step s27.

In steps 27, the terminal returns to the channel used before the start of the search process, and in step s28, the search process is finished and the transmitted data process is resumed.

Here, although a case is described in FIG. 10 wherein active scan is used for the AP search, passive scan may be used in place of active scan. When using passive scan, step s23 is unnecessary, and a reception acknowledgement of the beacon is performed in step s26.

In addition, the present invention can also be used in a wireless LAN system operating in ad-hoc mode.

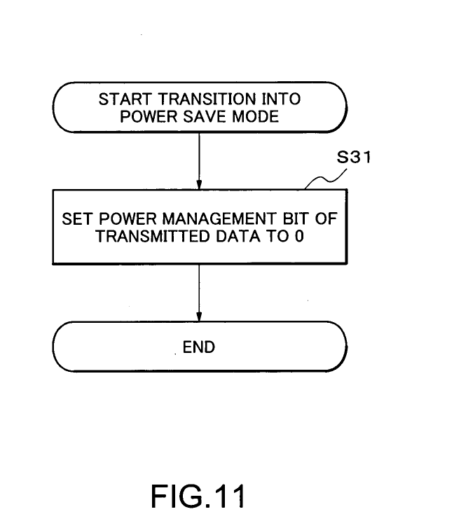

In step s3, the terminal sets the Power Management bit of the uplink data packet to “0”, as shown in FIG. 11, for transiting into active mode, in step 31.

### EMBODIMENT 1

Embodiment 1 is an exemplary search for a new AP, in such a condition that the terminal 104 operating in infrastructure mode is already associated with AP 101. Here, in the present embodiment, active scan is used in the search for a new target to be associated with.

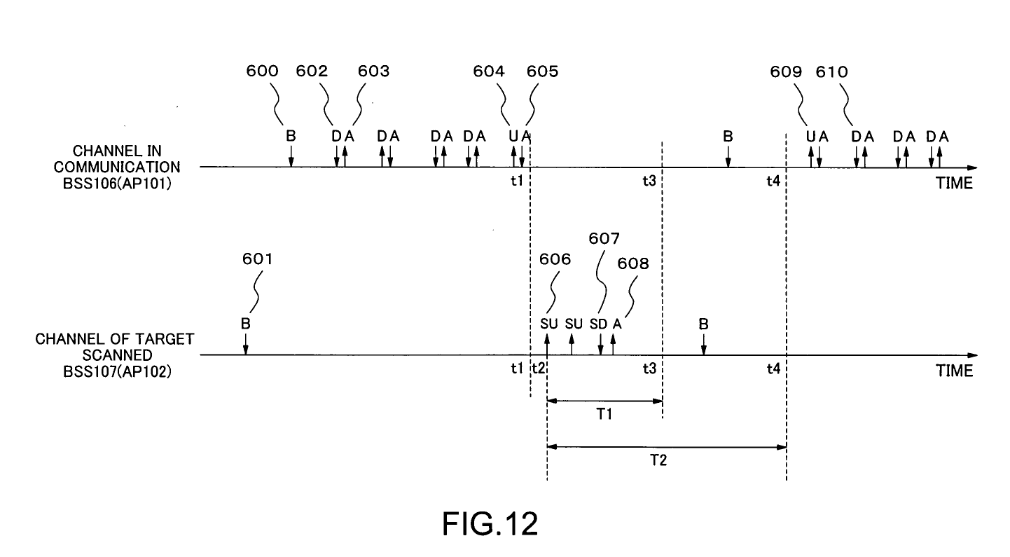

FIG. 12 illustrates how the terminal 104 already associated with AP 101 performs a search for AP 102 of FIG. 1. In FIG. 12, the horizontal axis represents time. The upward arrows represent signals transmitted by the terminal (uplink data packet) and downward arrows represent signals transmitted by the AP (downlink packet).

AP 101 and AP 102 periodically transmit beacons (B) 600 and 601 via different channels, respectively. In the present embodiment, the terminal 104 is associated with BSS 106 constituted with AP 101 as the core, and mainly receives downlink data packets. A packet 602 is a downlink data packet from AP101 to the terminal 104, and a packet 603 is a reception acknowledgement (ACK) returned by the terminal 104 in response to the downlink data packet 602.

The terminal 104 communicating with AP 101 migrates from the channel for AP 101 (channel currently in communication) to the channel of AP 102 from time point t1 in order to search for a new target to be associated with. The terminal 104 transmits an uplink data packet 604 to notify, at a time point before t1, AP 101 of transition into power saving mode. In this event, the Power Management bit of the packet is set to “1”.

If the terminal 104 does not have data to be transmitted to AP 101, the terminal 104 uses a Null function data frame to notify AP of power saving.

The Null function data frame has the same frame format as that of a normal data frame shown in FIG. 7. The Null function data frame is a frame in which Subtype 502 which expresses the type of frame is set to “0100”, and the frame body 503 is empty. On the contrary, in a normal data frame, the value of Subtype 502 is set to 0000.

In the embodiment 1, if the terminal 104 does not have an uplink data packet to be transmitted, the terminal 104 can notify AP 101 of transition into power saving mode by transmitting the Null function data packet 604 with the Power Management bit set to “1”. The terminal 104 can also keep the downlink data packet in AP 101 until the search is finished.

Upon receiving acknowledgement (ACK 605) for the notification of transition into power saving mode, the terminal 104 migrates to the channel of AP 102. Then, the terminal 104 transmits a probe request 606. Upon receiving the probe request 606, AP 102 returns a probe response 607. Packet 608 is an ACK corresponding to the probe response 607.

In FIG. 12, the terminal 104 receives the probe response 607 within a minimum channel time (T1) after transmission of the probe request 606. Therefore, the terminal 104 extends the search time from the minimum channel time (t1) to a maximum channel time (T2).

After the maximum channel time (T2) has passed, the terminal 104 returns to the channel of AP 101 at time point t4. The terminal 104 then notifies AP 101 of returning to active mode. The notification is performed by transmitting a packet 609 with the Power Management bit set to “0” to AP 101. If the terminal 104 does not have a data to be transmitted to AP 101, the terminal 104 transmits a Null function data packet with the Power Management bit set to “0” as the notification of returning to active mode.

Upon receiving the notification of returning to active mode, AP 101 transmits, to the terminal 104, the downlink data packet 610 and so forth which has been kept since the notification 604 of transition into power saving mode was received.

### EMBODIMENT 2

Embodiment 2 is another exemplary AP search performed under a condition such that the terminal 104 operating in infrastructure mode is communicating in association with AP 101. The search is performed by active scan also in this embodiment.

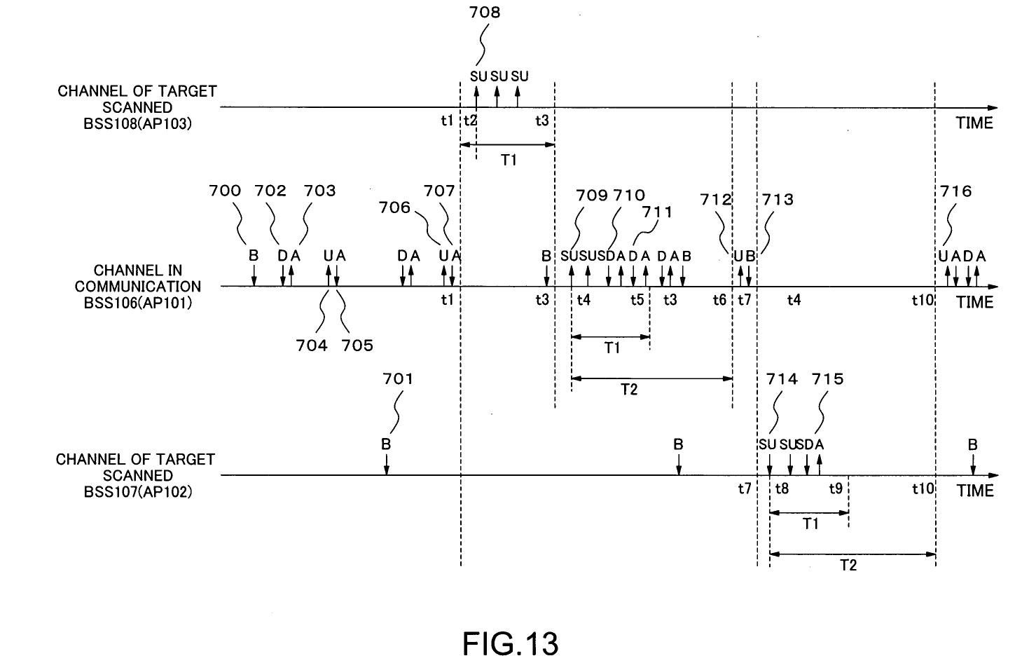

FIG. 13 illustrates how the terminal 104 of FIG. 1 performs a search for AP under a condition such that the terminal is communicating in association with AP 101. In FIG. 1, AP 101, AP 102, and AP 103 are communicating via different channels, respectively.

AP 101 and AP 102 periodically transmit beacons 700 and 701, which the terminal 104 is capable of receiving. On the other hand, since the terminal 104 is out of range where the radio wave of AP 103 reaches, as shown in FIG. 1, the terminal 104 cannot receive the beacon transmitted by AP 103.

The terminal 104 is associated with BSS 106 constituted with AP 101 as the core, and performs communication. Packets 702, 703, 704, and 705 represent, respectively, a downlink data packet from AP 101 to the terminal 104, ACK for the downlink data packet 702, uplink data packet from the terminal 104 to AP 101, and ACK for the Uplink data packet 704. The terminal 104 migrates from the channel currently in communication to the channel of AP 102 from time point t1 in order to search for a candidate target to be newly associated with. For preparation, the terminal 104 transmits, at a time point before t1, an uplink data packet 706 to AP 101. The Power Management bit of the packet 706 is set to “1”, whereby the terminal 104 notifies AP 101 of transition into power save mode.

AP 101, having received the notification of transition into power saving mode, stops transmitting packets to the terminal 104. AP 104 also keeps, inside it, packets which are not transmitted to the terminal 104 until it receives notification of returning to active mode from the terminal 104.

On the other hand, the terminal 104 starts searching for a candidate target to be newly associated with, from time point t1. Here, the terminal 104 has the channels of AP 101, AP 102, and AP 103 set as the channels to be searched for. In addition, the search order is set in the order of: channel of AP 103, channel of AP 101, then channel of AP 102.

The terminal 104 migrates from its channel to the channel of AP 103 at time point t1. Then, the terminal 104 transmits the probe request 708 to AP 103 at time point t2. AP 103 cannot receive the probe request since the terminal 104 is out of communicatable distance from AP 103. Thus, the terminal 104 cannot receive the response to the probe request 704 even if the minimum channel time (T1) has passed.

Therefore, in FIG. 13, the terminal 104 finishes searching for AP 103 at time point t3, and migrates to the channel of AP 101, which is the next target of the search. The terminal 104 then transmits a probe request 709 to AP 101 at time point t4.

Upon receiving the probe request 709, AP 101 returns a probe response 710 to the terminal 104. In FIG. 13, because the terminal 104 has received the probe response within a minimum channel time (T1), the search time is extended to a maximum channel time (T2).

On the other hand, AP 101 recognizes, by reception of the probe request, that the terminal 104 has released power saving mode, i.e., it is in active mode. This is because the probe request is a broadcast packet, with the Power Management bit is always set to “0”. AP 101 transmits, in sequence, downlink data packets 711 and so forth which have been buffered.

After the maximum channel time has passed, the terminal 104 finishes the search in the channel of AP 101. The terminal 104 transmits an uplink data packet 712 with the Power Management bit set to “1” again in order to transit to the channel of the subsequent AP 102, and notifies AP 101 of transition into power save mode. As thus described, the search can be continued without losing downlink data packets when searching for a channel of the target to be associated with, by notifying the AP, again, of transition into power saving mode.

Upon receiving ACK 713 for the notification 712 of transition into power saving mode, the terminal 104 migrates to the channel of AP 102 at time point t7. Then, as with the search process for AP 101, a probe request 714 is transmitted from the terminal 104 to AP 102. Upon receiving the probe request, AP 102 returns a probe response 715 to the terminal 104.

Here, in the description of the embodiment 2, although AP 101, AP 102, and AP 103 are described as operating indifferent channels, respectively, this condition is not necessarily essential. For example, AP 101 and AP 103 may use a same channel.

In FIG. 13, the search for AP is performed in the order such as: search for AP 103 then search for AP 101. If the channel of AP 103 is identical to that of AP 1013, the terminal 104 need not change the channel when searching for AP 103. In other words, the terminal 104 can search for AP 103 while still capable of receiving downlink data packet from AP 101. In this case, the terminal need not perform notification of transition into power save mode before time point t1. In other words, the embodiment 2 may be modified such that the notification of transition into power saving mode (notification 712 of transition into power saving mode, in FIG. 13) is transmitted before time point t7 of transition to the channel of AP 102 from the channels of AP 101 and AP 103. In addition, although the embodiment 2 uses active scan in the search for the AP, the modification is also effective when passive scan is used for AP search.

### EMBODIMENT 3

Embodiment 3 is an example wherein the terminal 104 of FIG. 1 operates in infrastructure mode and searches for AP using passive scan.

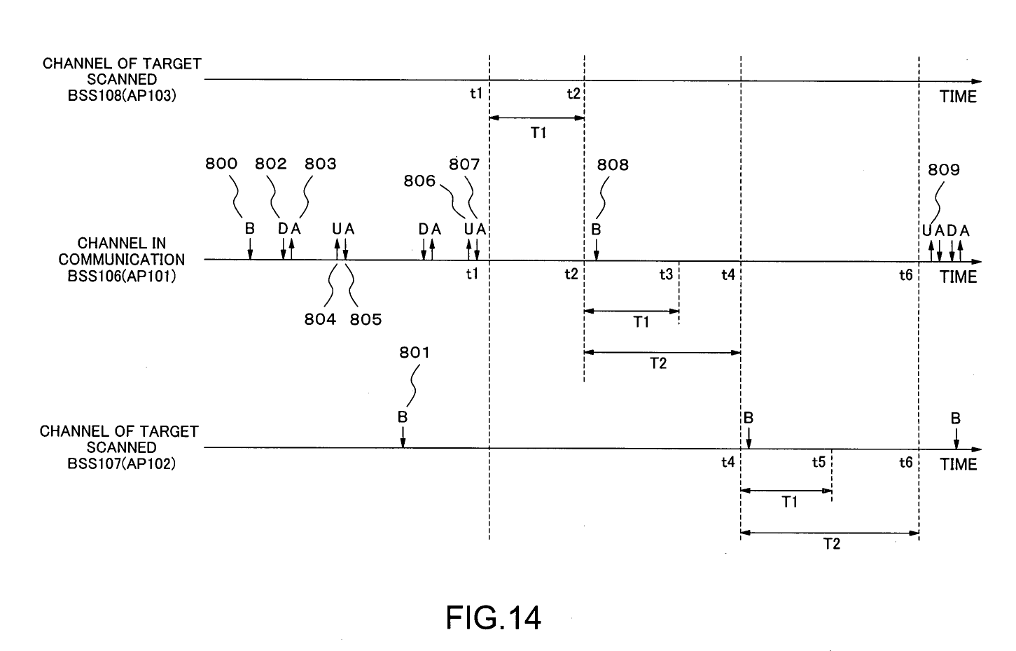

FIG. 14 illustrates signals which are exchanged between the terminal 104 of FIG. 1, and APs 101, 102 and 103.

AP 101 and AP 102 periodically transmit beacons 800 and 801. Since the terminal 104 is out of range where the radio wave of AP 103 reaches, as shown in FIG. 1, the terminal 104 cannot receive beacons from AP 103.

The terminal 104 is associated with BSS 106 constituted with AP 101 as the core, and performs communication. Packets 802, 803, 804, and 805 represent, respectively, a downlink data packet from AP 101 to the terminal 104, ACK for the downlink data packet 802, uplink data packet from the terminal 104 to AP 101, and ACK for the uplink data packet.

The terminal 104 migrates from the channel of AP 101 (channel currently in communication) to the channel of AP 102 from time point t1 for the searching. The terminal 104 transmits, at a time point before t1, an uplink data packet 806 with the Power Management bit set to “1”, to notify AP 101 of transition into power save mode. Packet 807 is the ACK for the notification of transition.

AP 101, having received the notification of transition into power saving mode, reserves transmitting downlink packets, and keeps to the downlink data packets addressed to the terminal 104 inside AP 101.

On the other hand, the terminal 104 starts searching for AP at time point t1, after having received ACK 807 for the notification of transition into power saving mode. Here, the terminal 104 has the channels of AP 101, AP 102, and AP 103 set as the channels to be searched for. In addition, the search order is set in the order of: channel of AP 103, channel of AP 101, then channel of AP 102. Furthermore, the scan type is set to passive scan which detects the existence of AP by receiving beacons in respective channels.

The terminal 104 migrates from its receiving channel to the channel of AP 103 at time point t1 and starts receiving the beacons of AP 103. As shown in FIG. 1, the terminal 104 cannot receive the beacons of AP 103 since the terminal 104 is out of communicatable distance from AP 103. Thus, the terminal 104 finishes searching for AP 103 after the minimum channel time (T1) has passed (time point t2). Then the terminal 104 migrates from its channel to the channel of AP 101 for the searching of the subsequent AP.

The terminal 104 performs, from time point t2, passive scan by receiving beacons in the channel of AP 101. In FIG. 14, because a beacon 808 of AP 101 is received during the minimum channel time (T1) and existence of AP 101 is detected, further receiving is performed until a maximum channel time T2 is reached, in the channel of AP 101.

After the maximum channel time (T2) has passed, the terminal 104 finishes searching in this channel and migrates to the channel of the subsequent AP 102, at time point t4.

In this embodiment, no packet will be transmitted at all from the terminal 104 by a passive scan, even if the search is performed in the communicating channel (i.e., channel of AP 101). Therefore, the notification of power saving mode presented to AP 101 in the uplink data packet 806 is still effective after time point t2. Therefore, it is possible to continue the search “without the necessity of notifying transition into power saving mode again when migrating to the subsequent channel as with the embodiment 2.”

At time point t4, the terminal 104 migrates to the channel of AP 102 and performs passive scan for AP 102. In FIG. 14, the search time is extended to a maximum channel time (T2), because the terminal 104 is receiving beacons of AP 102 during the minimum channel time (T1).

When the maximum channel time passes, AP search process of the terminal 104 is finished, and the terminal returns to the channel of AP 101 at time point t6. Then, the terminal 104 transmits an uplink data packet 809 with the Power Management bit set to “0”, and notifies AP 101 of return to active mode. In response to this notification, AP 101 transmits downlink data packets, which have been kept inside, to the terminal 104 during time points t1 to t6.

### EMBODIMENT 4

Embodiment 4 is an exemplary application of the present invention to a wireless LAN system which is different from the one in FIG. 1.

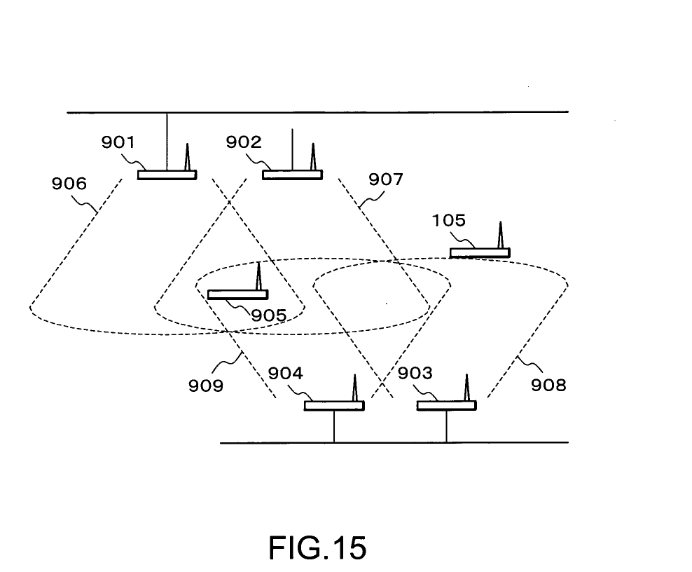

FIG. 15 illustrates the constitution of a wireless LAN system operating in infrastructure mode. Here, APs 901 to 904 constitute Basic Service Sets (BSS] 906 to 909, respectively, and the terminal 905 is communicating in association with AP 901. In addition, APs 901 to 904 are communicating via different channels, respectively. Furthermore, APs 901 to 904 transmit beacons with the beacon interval being BI=100 ms.

Since the terminal 905 is out of range where the radio wave of AP 903 reaches, as shown in FIG. 15, the terminal 905 cannot receive the beacon transmitted by AP 903.

In addition, the terminal 905 is configured such that all the channels in BSSs 906 to 909 except those communicating will be passively scanned in this order, as channels to be searched. Furthermore, the minimum channel time T1 and the maximum channel time T2 are set to 120[ms] and 160[ms], respectively.

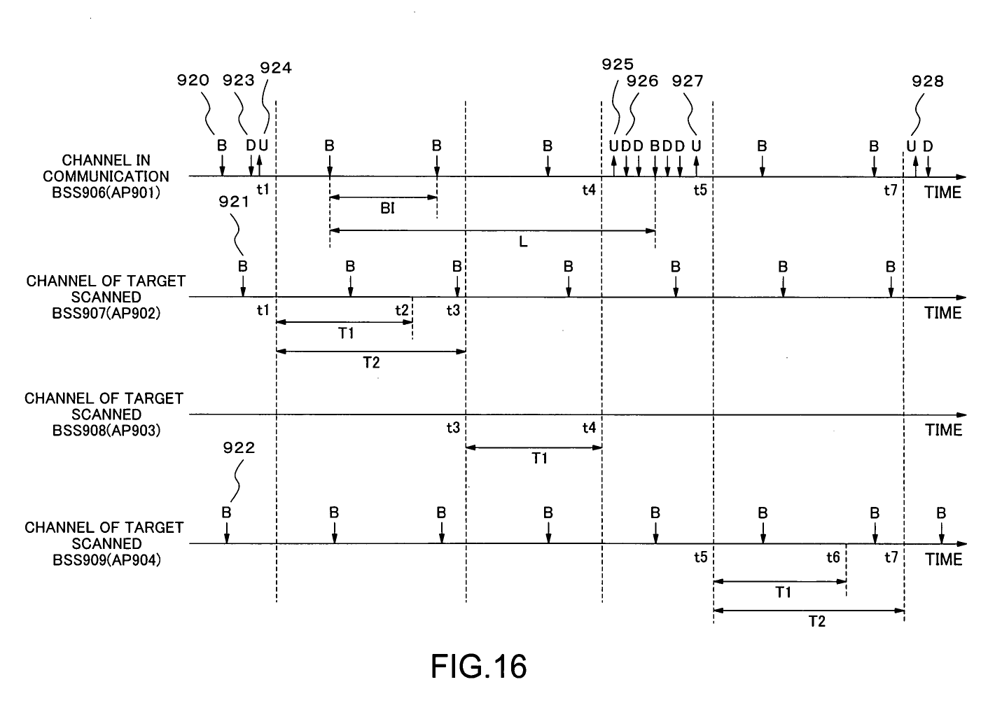

FIG. 16 depicts the signal flow with the horizontal axis representing time, upward arrows representing signals transmitted by the terminal 905 (uplink data packet), and downward arrows representing signals transmitted by the AP (downlink packet). Beacons 920 to 922 represent the beacons of AP 901, AP 902 and, AP-904. Packet 923 represents a downlink data packet transmitted from AP 901 to the terminal 905, and packet 924 represents an uplink data packet transmitted from the terminal 905 to AP 901. Here, in FIG. 16, description of ACK packets is omitted.

In addition, the Wakeup cycle, i.e. Listen Interval (L) in power saving mode is set to an interval of 3 beacons, i.e. 300 ms when the terminal 905 becomes associated with AP 901.

The Listen Interval is defined in IEEE 802.11. The terminal intermittently receives the beacon which is periodically (cycle: Beacon Interval) transmitted from the base station, or AP. The cycle of receiving beacons is Listen Interval. The terminal stays in a sleep (Doze) state except for a period in which it must receive beacons, thereby suppressing power consumption.

During the Listen Interval, the base station needs to buffer the packets addressed to the terminal. Therefore, the base station determines and notifies to the terminal an acceptable Listen Interval based on its memory capacity, when the terminal performs the process of being associated with the base station.

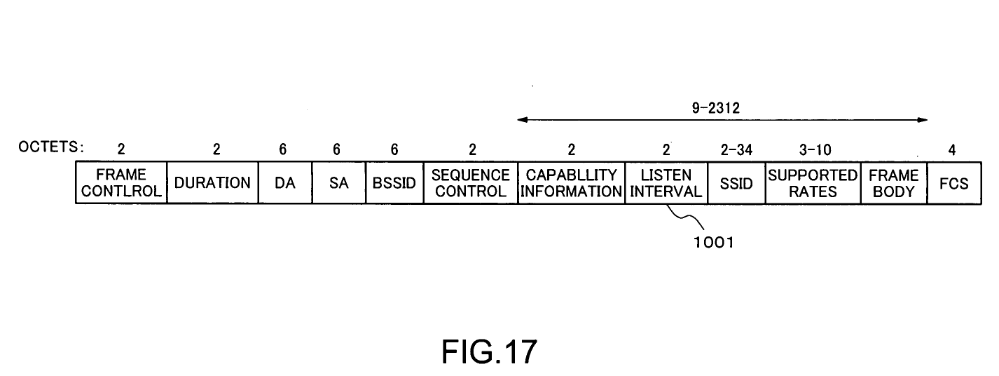

The Listen Interval, as shown in FIG. 17, is described in the Listen Interval field 1001 within the Association Management frame transmitted by the terminal when being associated with AP 901 and notified to AP.

Upon being notified of transition into power saving mode from the terminal, the AP starts buffering downlink data packets, wherein the AP can dispose of the downlink data packets which have been kept longer than the Listen Interval, if there is no transmission request (according to PS-Poll) from the terminal in power saving mode for a period exceeding the Listen Interval.

Thus, when it is necessary to receive downlink data packets which may exceed the Listen Interval, the terminal must interrupt the search for AP and receive the downlink data packets from the AP even if the terminal is in power saving mode.

In FIG. 16, the terminal 905 preliminarily notifies AP 901 of transition into power saving mode using the uplink data packet 924 in order to start searching for the AP at time point t1.

The terminal 905 migrates to the channel of BSS 907 at time point t1. Then, the terminal 905 monitors the beacons of the channel of AP 902 during the minimum channel time (T1) and detects the AP. Since the terminal 905 detected the beacon within the minimum channel time (T1) in the channel of BSS 907 (AP 902) in FIG. 16, the terminal 905 continues to search for the channel of BSS 907 until the maximum channel time (T2) passes.

Next, the terminal 905 starts searching for a channel of BSS 908 (AP 903) from time point t3. The terminal 905 monitors the channel during the minimum channel time T1 again, and attempts to detect a beacon. However, the terminal 905 finishes searching for AP 903 after T1 has passed (time point t4), because the terminal 905 cannot receive beacons from AP 903 as described above.

In the present embodiment, after having finished the search for one AP, the terminal performs subsequent determinations before proceeding to the next search for the channel. In other words, if, supposedly, a subsequent channel search is performed, the terminal determines whether or not the Listen Interval (300 ms) has been exceeded since the terminal temporarily left its currently associated AP.

Let us consider time point t4 of FIG. 16. In other words, let us consider the time which has passed since the terminal 905 left the channel which is communicating with the terminal 905 (i.e., channel of AP 901). The terminal 905 uses time T2 in the channel of BSS 907 (AP 902) and uses time T1 in the channel of BSS 908 (AP 903). In other words, at time point t4, T2+T1=160+120=280 ms has passed since the terminal left the channel of the currently associated target (AP 901). Therefore, at time point t4, the Listen Interval which is the buffering time of packets in AP 901 has not yet been exceeded. However, if we assume that the subsequent channel search is performed from time point t4, the Listen Interval will be exceeded at the end of the subsequent channel search. As mentioned above, downlink data packets which are kept in the AP for longer than the Listen Interval may be discarded.

Therefore, in FIG. 16, the terminal 905 receives AP 901 (return to the channel in communication) down link data packet before proceeding to the search for subsequent channel (i.e., time point t4) in order to prevent disposal of downlink data packet in AP 901. In other words, the terminal 905 migrates to the channel in communication at time point t4, and uses the uplink data packet 925 to notify AP 901 of transition into active mode. This notification also serves as the above-mentioned transmission request. The terminal 905 then receives the downlink data packets 926 and so forth which has been kept in AP 901.

As thus described, the present embodiment interrupts the search if the time of a single search is long and returns to the currently associated channel so as not to exceed the Listen Interval. Then the terminal 905 can prevent loss of downlink data packets by receiving the downlink data packets which are kept in the currently associated AP.

After having received the packets which have been kept in AP 101, the terminal 905 notifies AP 901 of transition into power saving mode, using the uplink data packet 927 again. The terminal 905 then migrates to the channel of BSS 909 (AP 904) which is the subsequent channel to be searched for.

The terminal 905 which has migrated to the channel of BSS 909 (AP 904) monitors the channel of AP 904 during the minimum channel time T1, and detects the beacons of AP 904. In FIG. 16, because the terminal 905 succeeded in detecting a beacon within the minimum channel time in the channel of BSS 909, the terminal 905 continues to search for the channel of BSS 909 until a maximum channel time (T) has passed. After having finished the search in BSS 909, the terminal 905 returns to the channel in communication at time point t7, and notifies AP 901 of returning to active mode using the uplink data packet 928.

Here, the Listen Interval in the present embodiment may be replaced by Delivery Traffic Indication Map (DTIM) cycle to implement the invention as well.

DTIM cycle is a cycle of the beacon timing with which the base station transmits broadcast packets. DTIM can be set independent of the above-mentioned Listen Interval.

Although the terminal can maintain the sleep state for a longer period and suppress power consumption by setting the Listen Interval longer, the possibility remains that reception loss of broadcast packets may occur, on the other hand. The modification into embodiment 4 solves the problem.

### EMBODIMENT 5

Although a wireless LAN system has been described as operating in infrastructure mode in embodiments 1 to 4, the present invention provides a similar advantage to wireless LAN systems operating in an ad-hoc mode.

Thus, in embodiment 5, examples wherein the present invention is applied to ad-hoc mode are described.

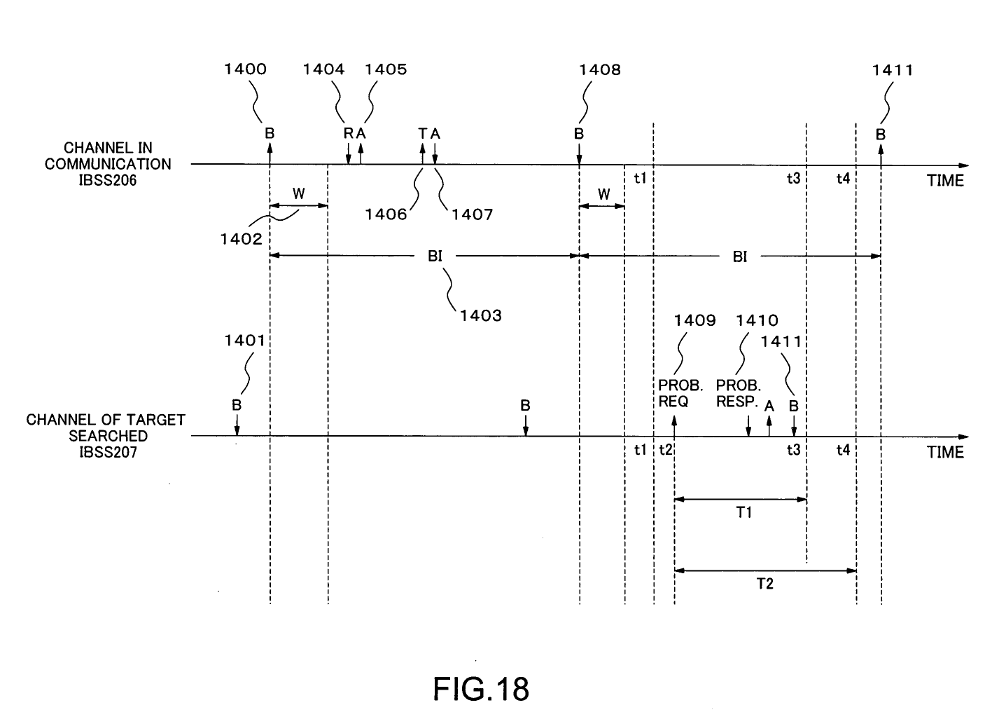

FIG. 18 illustrates how the terminal 203 of FIG. 2 operating in ad-hoc mode performs the search under a condition in which the terminal 203 is already associated with IBSS 206. FIG. 18 depicts the signal flow with horizontal axis representing the time, upward arrows representing signals transmitted by the terminal and downward arrows representing signals transmitted by other the terminals. IBSS 206 and IBSS 207 periodically transmit beacons 1400 and 1401 via different channels, respectively.

In addition, the terminal 203 is associated with IBSS 206 and performs communication. Here, the beacon-1400 is transmitted by the terminal 203, and the terminal 203 subsequently performs transmission and reception of the received data 1404 together with its ACK 1405, and the transmitted data 1406 together with its ACK 1407.

Here, beacon interval 1403 of IBSS 206 is BI, Announcement Traffic Indication Message (ATIM) Window 1402 width is W. IBSS requires beacons to be transmitted between the respective terminals according to a procedure using a back off timer as with normal data. The procedure is such that each the terminal provides its back off timer with a random number generated between zero and a defined value, and every terminal counts down its timer simultaneously at subsequent beacon transmission timings. The terminal which was the first to reach zero transmits a beacon. Here it is regulated that the terminal which transmitted a beacon must not transit into power saving mode until the next beacon timing. In addition, a condition must be maintained such that a terminal in power saving mode is also capable of receiving all the beacons, and during ATIM Window 1402, capable of receiving packets from other the terminals. Furthermore, the terminal which received an ATIM frame during ATIM Window must preserve the active status afterwards. This is because ATIM frame is a frame for notifying, when data to be transmitted by another the terminal is buffered, the terminal which is supposed to receive the data.

Having transmitted the beacon 1400, the terminal 203 cannot transit into power saving mode until the next beacon transmission timing. During ATIM Window 1402, the terminal 203 transmits and receives ATIM frames, if necessary. As a result of the transmission and reception of ATIM frames, the terminal 203 receives packet 1404 from another the terminal in IBSS 206, transmits ACK 1405 corresponding to packet 1404, transmits packet 1406 to another the terminal, and receives ACK 1407 corresponding to packet 1406.

When searching for another IBSS using power saving mode, the terminal 203 intentionally restrains transmission of beacons, even if the condition for sending beacon 1408 is satisfied. In other words, beacon transmission procedure using the back off timer is not performed. The purpose of this is to attempt transition into power saving mode by not transmitting beacon at this timing. Therefore, beacon 1408 is transmitted by another the terminal in IBSS 206. The terminal 203 satisfies the condition of transition into power saving mode, if it has not received ATIM frames addressed to itself in ATIM Window after beacon 1408, and if it does not keep data to be transmitted to another the terminal. This enables the terminal 203 to leave IBSS to search for another IBSS for a period until the time point at which the next beacon 1411 is supposed to be transmitted. The three facts that “the terminal 203 did not transmit a beacon, nor transmit an ATIM frame, nor receive an ATIM frame addressed to the terminal 203,” implicitly notify all of the terminals in IBSS 206 that “the terminal 203 will be in power saving mode until the next beacon transmission timing.”

In FIG. 18, the terminal 203, having satisfied the condition of transiting into power saving mode, migrates to the channel of IBSS 207 at time point t1. The terminal 203 then broadcasts a probe request 1409 to the other terminals in IBSS 207 at time point t2. Upon receiving a probe response 1410 within the minimum channel time T1, the terminal 203 returns ACK to the probe response 1410. The terminal 203, having received the probe response within T1, extends the search time until the maximum channel time T2.

After having searched for another IBSS, the terminal 203 must quickly return to the channel in communication by the next beacon timing 1411 and perform transmission or reception of beacons and reception in ATIM Window. In ad-hoc mode, unlike infrastructure mode, since the terminal must be active at every beacon timing, time management of the search for another IBSS must be done precisely. The same applies to conventional ad-hoc mode.

### EMBODIMENT 6

Embodiment 6 is an exemplary application of the present invention to a wireless LAN system operating in infrastructure mode, in the wireless LAN system constitution shown in FIG. 15.

As shown in FIG. 15, APs 901 to 904 constitute Basic Service Sets (BSS] 906 to 909, respectively, and the terminal 905 is communicating in association with AP 901. APs 901 to 904 are communicating via different channels, respectively. Additionally, in the present embodiment, the terminal 905 is scheduled to transmit uplink packets 1504 and 1506 to AP 901 with a predefined cycle M.

Since the terminal 905 is out of range where the radio wave of AP 903 reaches, as shown in FIG. 15, the terminal 905 cannot receive beacons from AP 903.

In addition, the terminal 905 is configured such that all the channels in BSSs 906 to 909 except those being associated will be passively scanned in this order, as channels to be searched. Furthermore, the minimum channel time T1 and the maximum channel time T2 are set to 120[ms] and 160[ms], respectively.

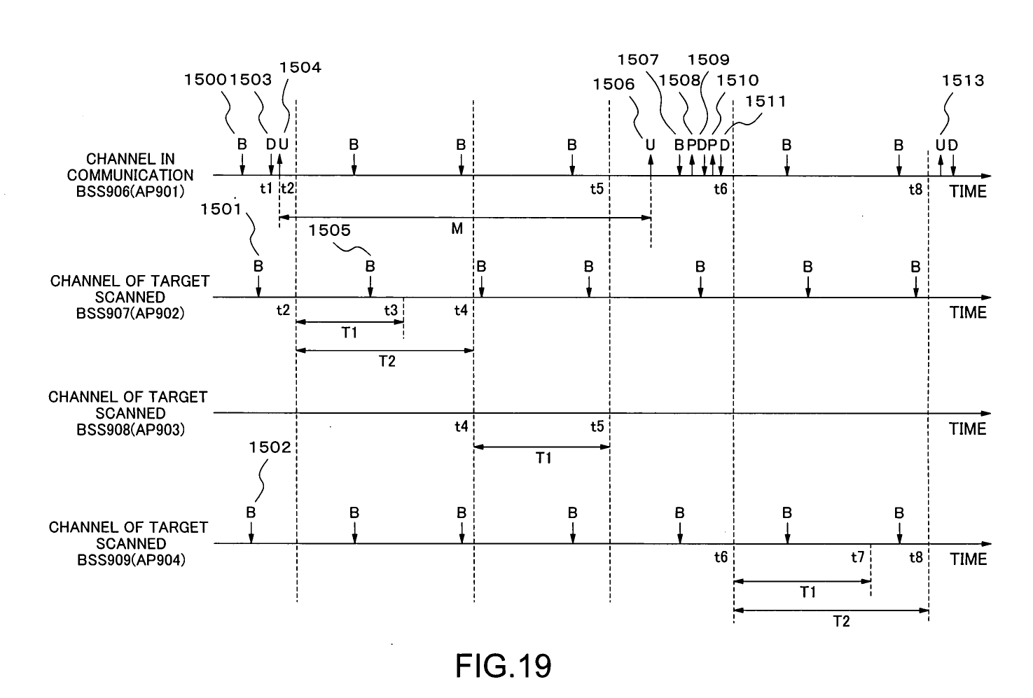

FIG. 19 depicts the signal flow with the horizontal axis representing time, upward arrows representing uplink data packets which are signals transmitted by the terminal, and downward arrows representing downlink packets which are signals transmitted by the AP. The beacons 1500 to 1502 are beacons transmitted from AP 901, AP 902 and, AP 904, respectively. The packet 1503 represents a downlink data packet from AP 901 to the terminal 905, and the packet 1504 represents an uplink data packet from the terminal 905 to AP 901. Here, in FIG. 19, description of ACK packets is omitted.

Additionally, the terminal 905 is scheduled to transmit uplink packets to AP 901 with a predefined cycle M. Here, M is set to be M=340 ms.

In FIG. 19, the terminal 905 notifies AP 901 of transition into power saving mode using the transmitted data packet 1504 occurred at time point t1. The Power Management Bit of the packet 1504 is set to be “1”.

The terminal 905 starts searching for AP at time point t2. The terminal 905, having migrated to the channel of BSS 907 (AP902), detects AP 902 by monitoring the channel and receiving beacons during the minimum channel time T1. The terminal 905, having succeeded in detecting beacon 1505 in the channel of BSS 907, it continues to search for the channel of BSS 907 until the maximum channel time (T2) passes.

The present embodiment determines the following at the end of the search for one channel. In other words, the terminal 905 determines whether or not the time which passed since the terminal temporarily left the currently associated AP exceeds M, when a subsequent search for channels was performed.

At time point t4, a time period T2 from time point t1 has passed. If we assume that a subsequent channel search was performed and the subsequent channel search supposedly required a time period T2, the estimated ending time point of the subsequent channel search would be 2×T2=320 ms after the terminal temporarily left the currently associated AP 901. The estimated time point is earlier than the time point at which the terminal 905 is supposed to transmit the subsequent uplink data packet.

Therefore, the terminal 905 starts searching for the channel of BSS 908 (AP 903) at time point t4. Here, detection of AP is also attempted by monitoring the channel during the minimum channel time and receiving the beacons. As described above, since the terminal 905 cannot receive beacons from AP 903, the terminal finishes the search in this channel after T1 has passed (time point t5).

Before proceeding to the search for the next channel, the terminal 905 calculates the time passed since it temporarily left the channel of AP 901. Because time T2 is used in the search for the channel of BSS 907, and time T1 for the channel of BSS 908, 280 ms has passed at time point t5 since the terminal 905 left the channel of AP 901. If a subsequent channel search is supposedly started at time point t5, the timing at which the uplink data packet to be transmitted by the terminal 905 is generated would be passed.

Thus, the terminal 905 returns to the channel in communication (channel of AP 901) at time point t5, and prepares for generation of uplink data packets supposed to be transmitted.

In other words, the terminal 905 transmits a transmission packet 1506. Here, the transmission packet 1506 is transmitted with the Power Management bit set to “1”, in order that the terminal 905 performs a next channel search. Hereafter, the terminal 905 waits to receive a beacon 1507.

The terminal 905 receives the beacon 1507 and, upon detecting inbound packets buffered therein, requests transmission (by PS Poll frames 1508 and 1510) of packets buffered in AP 901, then receives downlink data packets 1509 and 1511.

As thus described, if the time period of one search is long, it becomes possible to transmit uplink data packets at an appropriate timing, even in the middle of the search, by properly returning to the channel in communication so that the search time does not exceed the generation interval of uplink data packets to be transmitted.

After having received the packets which have been temporarily kept in AP 901, the terminal 905 migrates (time point t6) to the channel of BSS 909 which is the subsequent channel to be searched for. In this connection, a notification of power save mode may be made by using an ACK corresponding to the packet 1511. Here, the terminal 905 which has migrated to the channel of BSS 909 monitors the channel during the minimum channel time T1, and detects the AP by receiving its beacons. In FIG. 19, because the terminal 905 detected the beacon of AP 904 within the minimum channel time (T1), the terminal 905 continues to search for the channel of BSS 909 until a maximum channel time (T2) has passed. After having finished the search in BSS 909, the terminal 905 returns to the channel in communication (channel of AP 901) at time point t8.

At time point t8, since all the AP search is finished and it is no longer necessary to continue the power saving mode, the terminal 905 uses the uplink data packet 1513 to notify AP 901 of transition into active mode. However, at this time point, if the terminal 905 does not have a packet to be transmitted to AP 901, it notifies of transition into active mode using a Null function data frame.

While this invention has been described in connection with certain exemplary embodiments, it is to be understood that the subject matter encompassed by way of this invention is not be limited to those specific embodiments. On the contrary, it is intended for the subject matter of the invention to include all alternatives, modifications and equivalents as can be included with the spirit and scope of the following claims. Further, the inventor's intent is to retain all equivalents even if the claims are amended during prosecution.

What is claimed is:

1. A wireless LAN handover method for use in a wireless LAN system, comprising the steps of:
transmitting a notification, in which a wireless terminal associating with either a Basic Service Set (BSS) or an Independent Basic Service Set (IBSS), indicates transition into power saving mode, to the BSS or IBSS; and
searching for another BSS or IBSS through said wireless terminal after said notification of transition into power saving mode has been transmitted.

2. The wireless LAN handover method according to claim 1, wherein, if a wireless terminal currently associated with a first BSS searches for a second BSS which is using the same channel as with the currently associated BSS, and subsequently searches for a third BSS which is using another channel which is different from the one of the currently associated BSS, said terminal transmits, to said first BSS, said notification of transition into power saving mode, before migrating to said another channel.

3. The wireless LAN handover method according to claim 1, wherein, if a packet to be transmitted exists, said notification of transition into power saving mode is performed by transmitting the packet, with the Power Management bit of the packet being set to power saving mode.

4. The wireless LAN handover method according to claim 1, wherein, if a packet to be transmitted does not exist, said notification of transition into power saving mode is performed by transmitting a packet of Null function, with the Power Management bit of the packet being set to power saving mode.

5. The wireless LAN handover method according to claim 1, wherein, if the time point of the generation of a subsequent packet to be communicated with the currently associated BSS or IBSS is known, said wireless terminal selects an operation, before searching for another BSS or IBSS, of either continuing the search for said another BSS or IBSS, or interrupting the search to perform packet communication with the currently associated BSS or IBSS, based on the time period during which said terminal is away from the currently associated BSS or IBSS and the time period required for searching one channel.

6. The wireless LAN handover method according to claim 5, wherein, said subsequent packet is a beacon having a DTIM cycle, when said wireless terminal operates in infrastructure mode.

7. The wireless LAN handover method according to claim 5, wherein said subsequent packet is a beacon having a Listen Interval cycle, if said wireless terminal operates in infrastructure mode.

8. The wireless LAN handover method according to claim 5, wherein, if said wireless terminal has migrated to the currently associated channel in order to interrupt the search and perform communication of a packet in the currently associated BSS or IBSS, continuously searching for a BSS or IBSS in another channel, at the end of the communication in the currently associated BSS or IBSS.

9. The wireless LAN handover method according to claim 5, wherein, if said wireless terminal operates in infrastructure mode and migrates from searching for a BSS to communicating with the currently associated BSS, said wireless terminal transmits a notification of transition into active mode to notify said currently associated BSS of transition into active mode, either upon returning to the channel of said currently associated BSS or upon resuming communication.

10. The wireless LAN handover method according to claim 9, wherein, if a packet to be transmitted exists, said notification of transition into active mode is performed by setting the Power Management bit of said packet in active mode and transmitting said packet as an uplink data packet.

11. The wireless LAN handover method according to claim 9, wherein, if a packet to be transmitted does not exist, said notification of transition into active mode is made by transmitting a packet of Null function, with the Power Management bit of said packet being set to active mode.

12. A wireless terminal for use in a wireless LAN system, comprising:
a notification unit which transmits, when said terminal searches for a Basic Service Set (BSS) or Independent Basic Service Set (IBSS) which is different from the BSS or IBSS with which said terminal is currently associated with, a notification of transition into power saving mode which notifies said currently associated BSS or IBSS of transition into power saving mode; and
a search unit which searches, after said notification of transition into power saving mode has been transmitted, for another BSS or IBSS.

13. The wireless terminal according to claim 12, wherein, if said wireless terminal currently associated with a first BSS searches for a second BSS which is using the same channel as with said first BSS, and subsequently searches for a third BSS which is using a channel which is different from the one of said first BSS,
said notification unit transmits, to said first BSS, said notification of transition into power saving mode, before migrating to another channel.

14. The wireless terminal according to claim 12, wherein, if a packet to be transmitted exists, said notification of transition into power saving mode is performed by transmitting the packet, with the Power Management bit of the packet being set to power saving mode.

15. The wireless terminal according to claim 12, wherein, if a packet to be transmitted does not exist, said notification of transition into power saving mode is performed by transmitting a packet of Null function, with the Power Management bit of the packet being set to power saving mode.

16. The wireless terminal according to claim 12, further comprising:
a storage unit which stores the time point of occurrence the subsequent packet to be transmitted by the currently associated BSS or IBSS; and
a management unit which manages the time period during which a search is being performed away from the currently associated channel and manages the time required for searching for one channel,
wherein said wireless terminal is configured to select an operation of either continuing the search for another BSS or IBSS currently being searched for, or interrupting the search to perform packet communication with the currently associated BSS or IBSS.

17. The wireless terminal according to claim 16, wherein, said subsequent packet is a beacon having a DTIM cycle, when said wireless terminal operates in infrastructure mode.

18. The wireless terminal according to claim 16, wherein said subsequent packet is a beacon having a Listen Interval cycle, if said wireless terminal operates in infrastructure mode.

19. The wireless terminal according to claim 16, wherein, if said wireless terminal has migrated to the currently associated channel in order to interrupt the search and perform communication of a packet in the currently associated BSS or IBSS, said search unit will continue to search for a BSS or IBSS in another channel, at the end of the communication in the currently associated BSS or IBSS.

20. The wireless terminal according to claim 16, wherein, if said wireless terminal operates in infrastructure mode and migrates from searching for a BSS to communicating with the currently associated BSS, said notification unit transmits a notification of transition into active mode to notify said currently associated BSS of transition into active mode upon returning to the channel of said currently associated BSS.

21. The wireless terminal according to claim 20, wherein, if a packet to be transmitted exists, said notification of transition into active mode is performed by transmitting said packet, with the Power Management bit of said packet being set to active mode.

22. The wireless terminal according to claim 20, wherein, if a packet to be transmitted does not exist, said notification of transition into active mode is performed by transmitting a packet of Null function, with the Power Management bit of said packet being set to active mode.

23. A program product for instructing a computer to execute a handover function of a wireless terminal in a wireless LAN system, comprising the steps of:
notification step for transmitting, to a Basic Service Set (BSS) or an Independent Basic Service Set (IBSS) with which said wireless terminal is currently associated with, a notification of transition into power saving mode to notify that said terminal transits into power saving mode; and
search step of searching for another BSS or IBSS after said notification of transition into power saving mode has been transmitted.

24. The program product according to claim 23, wherein, if a wireless terminal currently associated with a first BSS searches for a second BSS which is using the same channel as with said first BSS, and subsequently searches for a third BSS which is using a channel which is different from the one of said first BSS,
said notification step transmits, to said first BSS, said notification of transition into power saving mode, before migrating to said another channel.

25. The program product according to claim 23, wherein, if a packet to be transmitted does not exist, said notification step performs said notification of transition into power saving mode by transmitting a packet of Null function, with the Power Management bit of the packet being set to power saving mode.

26. The program product according to claim 23, wherein, if the time point of the generation of a subsequent packet to be communicated with the currently associated BSS or IBSS is known, the wireless terminal selects an operation, before searching for another BSS or IBSS, of either continuing the search for said another BSS or IBSS or interrupting the search to perform packet communication with the currently associated BSS or IBSS, based on the time period during which said terminal is away from the currently associated BSS or IBSS and the time period required for searching one channel.

27. The program product according to claim 26, wherein, if said wireless terminal has migrated to the currently associated channel in order to interrupt the search and perform communication of a packet in the currently associated BSS or IBSS, the search for a BSS or IBSS in another channel will be continued, at the end of the communication in the currently associated BSS or IBSS.

28. The program product according to claim 26, further comprising, if said wireless terminal operates in infrastructure mode and migrates from searching for a BSS to communicating with the currently associated BSS, the step of transmitting a notification of transition into active mode to notify said currently associated BSS of transition into active mode upon returning to the channel of said currently associated BSS.

29. The program product according to claim 28, said notification of transition into active mode further comprising, if a packet to be transmitted does not exist, the step of transmitting a packet of Null function, and setting the Power Management bit of said packet being to active mode.

30. A wireless communications system comprising one or more terminals and a plurality of base stations, each of said one or more terminals being associated with one of said plurality of base stations, each of said terminals including
a notification unit which transmits, when said terminal searches for a base station which is different from the base station with which said terminal is currently associated with, a notification of transition into power saving mode which notifies said currently associated base station of transition into power saving mode; and
a search unit which searches, after said notification of transition into power saving mode has been transmitted, for another base station,
wherein said base station reserves transmitting packets to said terminal, upon reception of a notification of transition into power saving mode from one of said wireless terminals.

31. The wireless communications system according to claim 30, wherein, if a packet to be transmitted does not exist, said notification of transition into power saving mode is performed by transmitting a packet of Null function, with the Power Management bit of the packet being set to power saving mode.

32. The wireless communications system according to claim 30, wherein, if said wireless terminal returns to the currently associated base station either after or during the search for a base station, said notification unit transmits, to the currently associated BSS, a notification of transition into active mode transition to notify that said wireless terminal transits into active mode.

33. A wireless LAN system with a plurality of terminals are operating in ad-hoc mode, forming a plurality of Independent Basic Service Sets (IBSSs), wherein
each of said plurality of terminals comprises a search unit which searches for another IBSS; and
each of said plurality of terminals does not, at a timing which is possible to transmit a beacon, transmit the beacon, and actuates said search unit after having received a beacon from another terminal associated with the IBSS with which said terminal is associated with, and an ATIM window following said beacon.
